(19) United States
(12) Patent Application Publication
(10) Pub. No.: US 2014/0358745 A1
(43) Pub. Date: Dec. 4, 2014

(54) AUTOMATED ACCOUNTING METHOD

(71) Applicant: LedgerPal Inc., Kemptville (CA)

(72) Inventor: Robert Russell Lunan, Kemptville (CA)

(73) Assignee: LedgerPal Inc., Kemptville (CA)

(21) Appl. No.: 14/295,433

(22) Filed: Jun. 4, 2014

Related U.S. Application Data
(60) Provisional application No. 61/830,727, filed on Jun. 4, 2013.

(51) Int. Cl. G06Q 40/00; G06Q 20/40

(52) U.S. Cl. CPC G06Q 40/12; G06Q 20/40
USPC 705/30

(57) ABSTRACT

A method of providing financial services to a user that includes: providing a web based application allowing the user to enter data relating to an enterprise; executing within the web based application at least one algorithm of a plurality of algorithms upon the data entered, with at least one algorithm selected in dependence upon at least the data entered; and determining with the web based application whether to perform an action of a plurality of actions in dependence upon the result of executing at least one algorithm.

### CROSS-REFERENCE TO RELATED APPLICATIONS

This patent application claims the benefit of U.S. Provisional Patent Application U.S. 61/830,727 filed Jun. 4, 2013 entitled “Automated Accounting Method.”

### FIELD OF THE INVENTION

This invention relates to accounting and more particularly to exploiting artificial intelligence processing and hosted services to automate the inputting, processing, and outputting of account transaction data and reports.

### BACKGROUND OF THE INVENTION

Accounting, or accountancy, is the measurement, processing and communication of financial information about an economic entity or entities. Accounting measures the results of an organization's economic activities and conveys this information to a variety of users including investors, creditors, management, and regulators.

Accounting can be divided into several fields including financial accounting, management accounting, auditing, and tax accounting. Financial accounting focuses on the reporting of an organization's financial information, including the preparation of financial statements, to external users of the information, such as investors, regulators and suppliers; and management accounting focuses on the measurement, analysis and reporting of information for internal use by management. The recording of financial transactions, so that summaries of the financials may be presented in financial reports, is known as bookkeeping, of which double-entry bookkeeping is the most common system.

Within business today accounting is facilitated by accounting organizations such as standard-setters, accounting firms and professional bodies. Financial statements are usually audited by accounting firms, and are prepared in accordance with generally accepted accounting principles (GAAP). Whilst many laborious practices may be simplified with the help of computer software these tools historically have been targeted at those already familiar with and performing these tasks. Whilst within large businesses and enterprises this software is typically enterprise resource planning (ERP) software providing a comprehensive, centralized, integrated source of information that these businesses and enterprises can use to manage all major business processes, from purchasing to manufacturing to human resources such ERP systems are not viable a wide range and large number of smaller businesses/enterprises/sole proprietorships/family businesses etc. Such ERP software can replace a large number of individual software programs that were previously used and, hence, these smaller businesses/enterprises/sole proprietorships/family businesses etc. are currently forced to employ or seek software tools offering some integration of accounting elements.

Accordingly, within the prior art a range of accounting software systems, i.e. an application software, have been developed that record and process accounting transactions within functional modules such as accounts payable, accounts receivable, payroll, and trial balance. These function as an accounting information system and range from those developed in-house by the company or organization using it, those purchased from a third party, or those based upon a combination of a third-party application software packages with local modifications.

Such systems typically focus to a series of core modules including, but not limited, to the following:

Accounts receivable—where the company enters money received;

Accounts payable—where the company enters its bills and pays money it owes;

General ledger—the company's “books”;

Billing—where the company produces invoices to clients/customers;

Stock/inventory—where the company keeps control of its inventory;

Purchase order—where the company orders inventory;

Sales order—where the company records customer orders for the supply of inventory; and

Bookkeeping—where the company records collection and payment.

However, there are a variety of other aspects to accounting for a business/enterprise including, but not limited, to:
Debt collection—where the company tracks attempts to collect overdue bills (sometimes part of accounts receivable);
Electronic payment processing;
Expenses—where employee business-related expenses are entered;
Inquiries—where the company looks up information on screen without any edits or additions;
Payroll—where the company tracks salary, wages, and related taxes;
Reports—where the company prints out data;
Timesheet—where professionals (such as attorneys and consultants) record time worked so that it can be billed to clients; and
Purchase requisition—where requests for purchase orders are made, approved and tracked
Reconciliation—compares records from parties at both sides of transactions for consistency.
Journals

Whilst for many small enterprises etc. the importance of accounting may seem secondary against day-to-day operations there are potentially severe penalties for the owners and directors of businesses through incorrect reporting to financial and regulatory authorities. Accordingly, today it would be fair to categorise accounting as:

Legally required and expensive;

Difficult for owner-operators, requiring knowledge of accounting principles;

Boring, time consuming and prone to human errors;

Only gives after-the-fact numbers;

Generating future projections difficult and expensive; and

Time consuming and seen as overhead when should be growing business.

Accordingly, it would be beneficial to provide a wide range of businesses with a financial accounting system and financial reporting application/platform (FRSFRAP) that:
Runs itself in that apart from data entry no other actions are essentially required by the user;
Highly secure to address today's evolving threats and requirements for data security/privacy;
Cloud-based so that it is available anywhere/anytime to the user(s);
Provides projections;
Automatically performs the required reconciliations;
Exploits artificial intelligence to process data and generate reports;
Provides business intelligence reports;
Reduces the up-front installation and entry requirements/up-front costs; and
Significantly reduces labour costs/overhead to operate.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to accounting and more particularly to exploiting artificial intelligence processing and hosted services to automate the inputting, processing, and outputting of account transaction data and reports.

In accordance with an embodiment of the invention there is provided a method of providing financial services to a user comprising:
providing a web based application allowing the user to enter data relating to an enterprise;
executing within the web based application at least one algorithm of a plurality of algorithms upon the data entered, the at least one algorithm selected in dependence upon at least the data entered; and
determining with the web based application whether to perform an action of a plurality of actions in dependence upon the result of executing the at least one algorithm of a plurality of algorithms upon the data entered by the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts an exemplary user authentication and data processing flow for a FRSFRAP according to an embodiment of the invention;

FIG. 4 depicts an initial dashboard presented to a user of a FRSFRAP according to an embodiment of the invention;

FIG. 5 depicts dashboard navigation menus presented to a user of a FRSFRAP according to an embodiment of the invention;

FIGS. 6 to 8 depict customer dashboards presented to a user of a FRSFRAP according to an embodiment of the invention;

FIGS. 9 and 10 depict customer estimate dashboards presented to a user of a FRSFRAP according to an embodiment of the invention;

FIGS. 11 to 13 depict invoicing and customer payment dashboards presented to a user of a FRSFRAP according to an embodiment of the invention;

FIGS. 14 to 16 depict vendor dashboards presented to a user of a FRSFRAP according to an embodiment of the invention;

FIGS. 17 and 18 depict expense dashboards presented to a user of a FRSFRAP according to an embodiment of the invention;

FIGS. 19 to 22 depict purchase order dashboards presented to a user of a FRSFRAP according to an embodiment of the invention;

FIGS. 23 to 25 depict general ledger dashboards presented to a user of a FRSFRAP according to an embodiment of the invention;

FIGS. 26 to 30 depict inventory dashboards presented to a user of a FRSFRAP according to an embodiment of the invention;

FIG. 31 depicts a bank statement dashboard presented to a user of a FRSFRAP according to an embodiment of the invention;

FIGS. 32 to 34 depict accounts payable aging dashboards presented to a user of a FRSFRAP according to an embodiment of the invention;

FIGS. 35 and 36 depict a balance sheet dashboard presented to a user of a FRSFRAP according to an embodiment of the invention;

FIGS. 37 to 40 depict reporting dashboards presented to a user of a FRSFRAP according to an embodiment of the invention;

FIGS. 41 and 42 depict profit and loss dashboard presented to a user of a FRSFRAP according to an embodiment of the invention;

FIGS. 43 to 47 depict reporting dashboards presented to a user of a FRSFRAP according to an embodiment of the invention; and

FIG. 48 depicts a PayPal™ importing dashboard presented to a user of a FRSFRAP according to an embodiment of the invention.

### DETAILED DESCRIPTION

The present invention is directed to accounting and more particularly to exploiting artificial intelligence processing and hosted services to automate the inputting, processing, and outputting of account transaction data and reports.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, wearable device, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” as used herein and throughout this disclosure, refers to an electronic devices worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, jewelry, and sensors.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr, Instagram, reddit and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, Ushahidi, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, a service provider, a political party, an advocacy group, an activist group, a government, a government organization, and a non-government organization. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals who may, but not limited to, monitor, acquire, store, transmit, process, generate, participate, use, and manage either locally or remotely by their engagement with a service provider, third party provider, enterprise, social network, social media etc. via a dashboard, web service, website, software plug-in, software application, graphical user interface, for example, one or more aspects of a micro-crowd sourcing system and micro-crowd sourcing application/platform according to an embodiment of the invention. This includes, but is not limited to, private individuals, employees of organizations and/or enterprises, members of community organizations, members of charity organizations, men, women, children, and teenagers. In its broadest sense the user may further include, but not be limited to, software systems, mechanical systems, robotic systems, android systems, etc. that may be characterised by an ability to at least one of monitor, acquire, store, transmit, process, generate, participate, use, and manage one or more aspects of a micro-crowd sourcing system and micro-crowd sourcing application/platform according to an embodiment of the invention.

“User information” as used herein may refer to, but is not limited to, user behavior information, user profile information, user geo-location information, user biometric information, and estimation(s) and/or projection(s) of user information derived from current and/or historical biometric information. “Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, a Simple Message System (SMS) message, data transmitted via a wired interface, data transmitted via a wireless interface etc. The digital content may be any digital data that is at least one of generated, selected, created, modified, and transmitted in response to a user request, said request may be a query, a search, a trigger, an alarm, and a message for example.

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

A “screen” and/or “dashboard” as used herein may refer to, but is not limited to, a display screen forming part or all of a user interface presented to a user executing or accessing a financial accounting system and financial reporting application/platform (FASFRAP) according to embodiments of the invention. Within a broader approach a screen and/or dashboard may be displayed in other formats according to the display capabilities of the PED or FED upon which the digital content within the screen and/or dashboard is presented. Accordingly, whilst embodiments of the invention are described with respect to devices such as smartphones, tablets, laptops etc. with good graphic display capabilities the embodiments of the invention may be implemented within other PEDs and/or FEDs without such graphics capabilities, e.g. generic cellular telephones, by exploiting less graphical and/or non-graphical implementations. For example, each dashboard may be replaced with a text, SMS message, or elements of an email whilst a screen may be replaced with an email, for example.

Within the prior art in order to provide accounting an enterprise had three options:
Do It Yourself using a commercial accounting software package, e.g. Quickbooks™ or Sage 50, which appear to provide solutions to small businesses etc. but are deceptive and generally only accurate if you have accounting knowledge and present many challenges managing the files systems.
Do It Yourself using a spreadsheet, which is very time consuming, liable to errors, etc.
Hire a bookkeeper or staff accountant which is expensive.

Accordingly, it would be beneficial to provide a wide range of businesses with a financial accounting system and financial reporting application/platform (FRSFRAP) that:
Runs itself in that apart from data entry no other actions are essentially required by the user;
Highly secure to address today's evolving threats and requirements for data security/privacy;
Cloud-based so that it is available anywhere/anytime to the user(s);
Provides projections;
Automatically performs the required reconciliations;
Exploits artificial intelligence to process data and generate reports;
Provides business intelligence reports;
Reduces the up-front installation and entry requirements/up-front costs; and
Significantly reduces labour costs/overhead to operate.

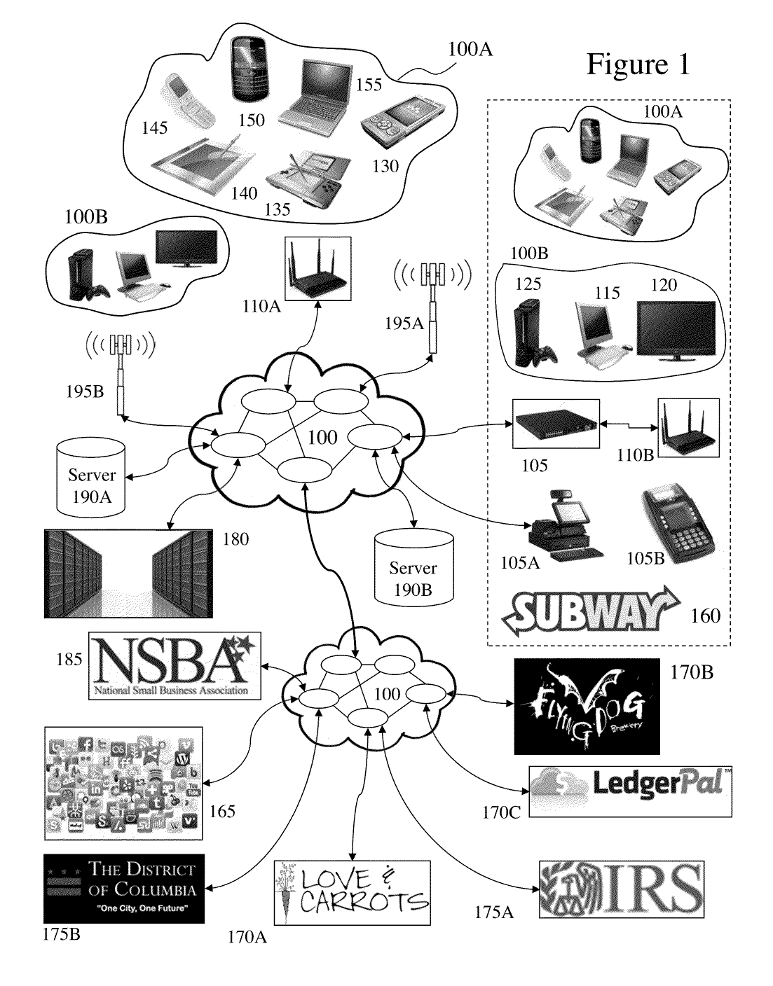

Referring to FIG. 1 there is depicted a network environment 100 within which embodiments of the invention may be employed supporting financial accounting system and financial reporting application/platforms (FASFRAPs) according to embodiments of the invention. Such FASFRAPs, for example supporting multiple channels and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. WalMart™, within which other first and second user groups 100A and 100B exist. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Also depicted as associated with Enterprise 160 are point-of-sale (POS) terminal 105A and POS handheld 105B representing devices with which a user may provide and/or acquire information via a near-field communication (NFC) according to a NFC protocol. Such protocols include, but are not limited, to those based on existing radio-frequency identification (RFID) standards including ISO/IEC 14443 and FeliCa together with standards built upon them such as ISO/IEC 18092 and those defined by the NFC Forum. Applications include contactless transactions, data exchange, and simplified setup of more complex communications such as Wi-Fi as well as communication between a NFC device and an unpowered NFC chip, typically referred to as a “tag”. For example, two devices may employ NFC to initially share MAC Address and IP addresses and then use Wi-Fi Direct to share files and documents.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, first and second user networks 170A and 170B respectively, e.g. Love and Carrots and Flying Dog Brewery, both small businesses in Washington, D.C., USA, FASFRAP provider 170C, e.g. LedgerPal™, and first to second regulatory or tax authorities 175A and 175B respectively, e.g. Internal Revenue Service (IRS) and Office of Tax and Revenue, The District of Columbia, as well as first and second servers 190A and 190B which together with others, not shown for clarity. Also depicted is advisor 185, e.g. National Small Business Association. First and second servers 190A and 190B may host according to embodiments of the inventions multiple services associated with a provider of micro-crowd sourcing systems and micro-crowd sourcing applications/platforms (FASFRAPs); a provider of a SOCNET or Social Media (SOME) exploiting FASFRAP features; a provider of a SOCNET and/or SOME not exploiting FASFRAP features; a provider of services to PEDS and/or FEDS; a provider of one or more aspects of wired and/or wireless communications; an Enterprise 160 exploiting FASFRAP features; license databases; content databases; image databases; content libraries; customer databases; websites; and software applications for download to or access by FEDs and/or PEDs exploiting and/or hosting FASFRAP features. First and second servers 190A and 190B may also host for example other Internet services such as a search engine, financial services, third party applications and other Internet based services.

Accordingly, a consumer and/or enterprise (CONENT) may exploit a PED and/or FED within an Enterprise 160, for example, and access one of the first or second servers 190A and 190B respectively to perform an operation such as accessing/downloading an application which provides FASFRAP features according to embodiments of the invention; execute an application already installed providing FASFRAP features; execute a web based application providing FASFRAP features; or access content. Similarly, a CONENT may undertake such actions or others exploiting embodiments of the invention exploiting a PED or FED within first and second user groups 100A and 100B respectively via one of first and second cellular APs 195A and 195B respectively and first Wi-Fi nodes 110A.

Accordingly, whilst embodiments of the invention are described below in respect of a CONTENT accessing a FASFRAP according to embodiments of the invention with respect to devices such as smartphones, tablets, laptops etc. with good graphic display capabilities the embodiments of the invention may be implemented within other PEDs and/or FEDs without such graphics capabilities, e.g. generic cellular telephones, that are also supported by the communications network described supra in respect of FIG. 1. Accordingly a CONTENT exploiting less graphical and/or non-graphical based FEDs and/or PEDs within first and second user groups 100A and 100B may be supported via the FASFRAP features and their communications via the network 100 to first and second servers 190A and 190B respectively. For example, rather than a graphical user interface (GUI) within an application hosted and launched upon the CONTENT's PED and/or FED then communications may be performed through one or more other channels including, but not limited to, rendering the content (e.g. text and/or images) for the GUI into an electronic message, e.g. email, text, or SMS according to the capabilities of the CONTENT's PED and/or FED. Similarly, multiple elements within the content to be rendered on a GUI may be reduced to a series/set of electronic messages such that, for example, a set of 10 cards each relating to a different microaction are rendered as an email, 10 SMS messages, etc.

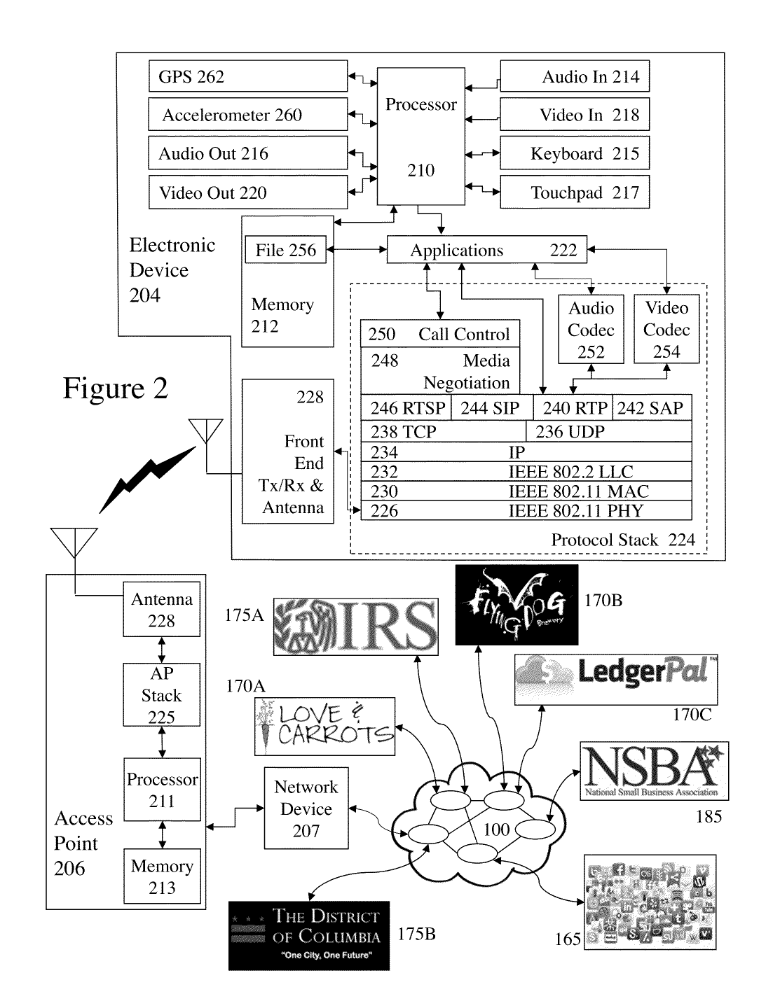

Now referring to FIG. 2 there is depicted an electronic device 204 and network access point 207 supporting FASFRAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and SOCNETS 165, first and second user networks 170A and 170B respectively, e.g. Love and Carrots and Flying Dog Brewery, both small businesses in Washington, D.C., USA, FASFRAP provider 170C, e.g. LedgerPal™, and first to second regulatory or tax authorities 175A and 175B respectively, e.g. Internal Revenue Service (IRS) and Office of Tax and Revenue, The District of Columbia, as well as first and second servers 190A and 190B which together with others, not shown for clarity. Also depicted is advisor 185, e.g. National Small Business Association.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Within the descriptions below a user is referred to as performing actions. It would be evident to one skilled in the art that the user so referred to may be and individual (e.g. consumer), part of an enterprise, a CONTENT as described supra, or a combination thereof.

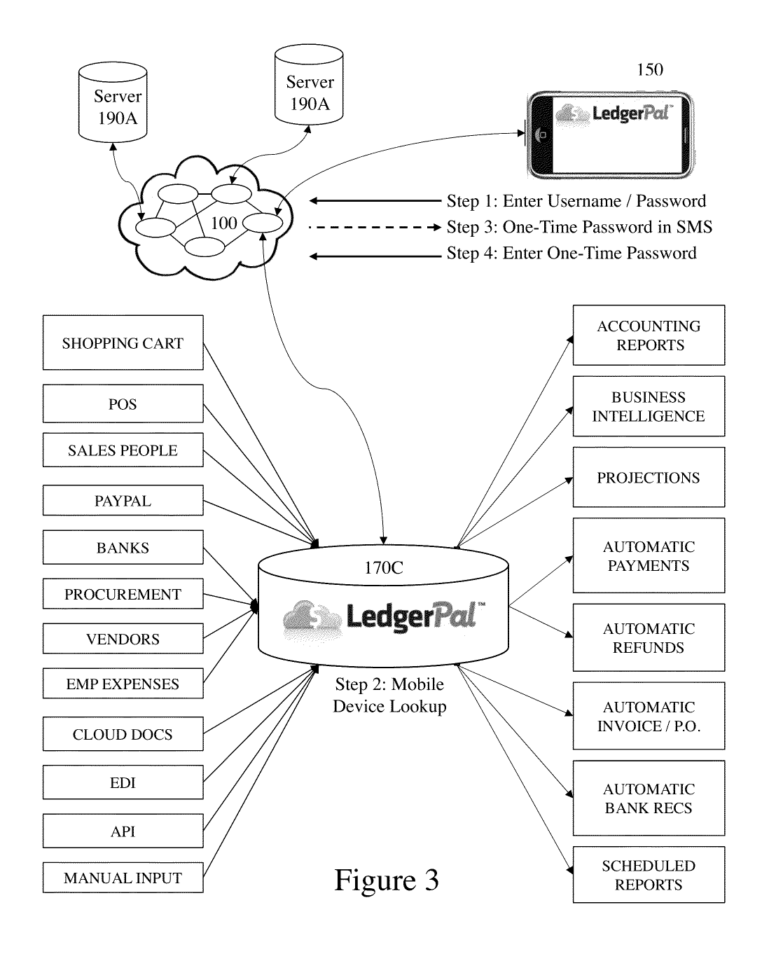

Now referring to FIG. 3 there is depicted an exemplary user authentication and data processing flow for a FRSFRAP according to an embodiment of the invention. Accordingly, a user upon a PED, e.g. smartphone 150, accesses the RSFRAP provider 170C via network 100 using a two-factor authentication process wherein:
Step 1: User enters username and password (first factor);
Step 2: User device lookup based upon username and password;
Step 3: One Time Password (second factor) sent to user on PED via SMS, for example;
Step 4: User enters one time password.

Once authenticated then the user may access one or more FRSFRAP features according to embodiments of the invention including, but not limited to, shopping carts of customers, point of sale (POS) terminals, sales people, electronic money transfers (e.g. PayPal™), bank records, procurement records, vendor data, employee expenses, cloud (i.e. Internet) accessible documents, electronic data interchange (EDI), application programming interface(s) (APIs), and providing manual input. Accordingly, the user may then subsequently be provided with or be able to have performed accounting reports, business intelligence, projections, automatic payments, automatic refunds, automatic invoicing, automatic purchase order generation, automatic bank reconciliation, and scheduled reports.

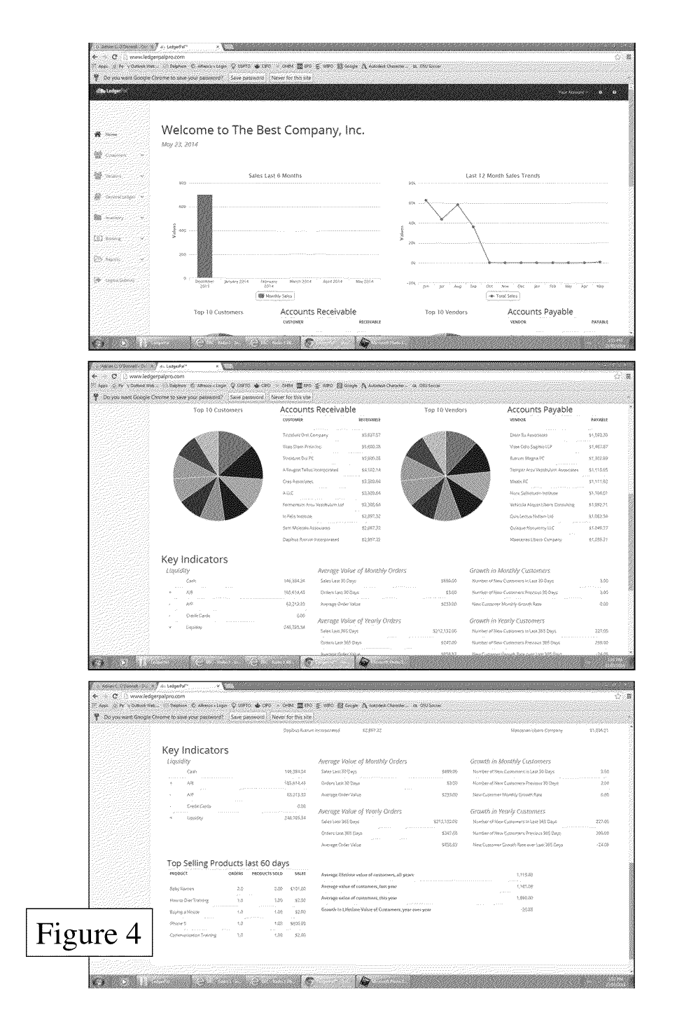

FIG. 4 there is depicted an initial dashboard presented to a user of a FRSFRAP according to an embodiment of the invention upon their successful logging into the FRSFRAP. Accordingly, the dashboard contains sections relating to the last 6 months sales, last 12 months sales trend, accounts receivable for top 10 customers, top 10 vendors, key indicators and top selling products in the last 60 days. What elements are displayed within the initial dashboard, their number, chart/graph type etc. may be customized by the user provided that they have the appropriate access rights to the FRSFRAP. Down the left hand side of the initial dashboard are navigation headers indicated as Home, Customers, Vendors, General Ledger, Inventory, Banking, Reports, and Logout (admin). Accordingly, selection of Logout (admin) allows an administration level access user to login, perform administration functions as necessary before logging out into the FRSFRAP without having to exit the FRSFRAP and login again with a different user identity and password. As described supra in respect of FIG. 3 the logging in of a user is performed using a 2-factor authentication process allowing the user to access the web (cloud) based FRSFRAP from a PED and/or FED anywhere they are at that particular time. Accordingly, a salesperson may be given access to real time current inventory levels, purchase orders, commitments, etc. whilst at the customer's office, retail store, etc. Similarly, a query from anyone can be addressed by the enterprise at any time allowing a small enterprise to offer extended support services to their customers as the enterprise personnel can access the records at any time from any location.

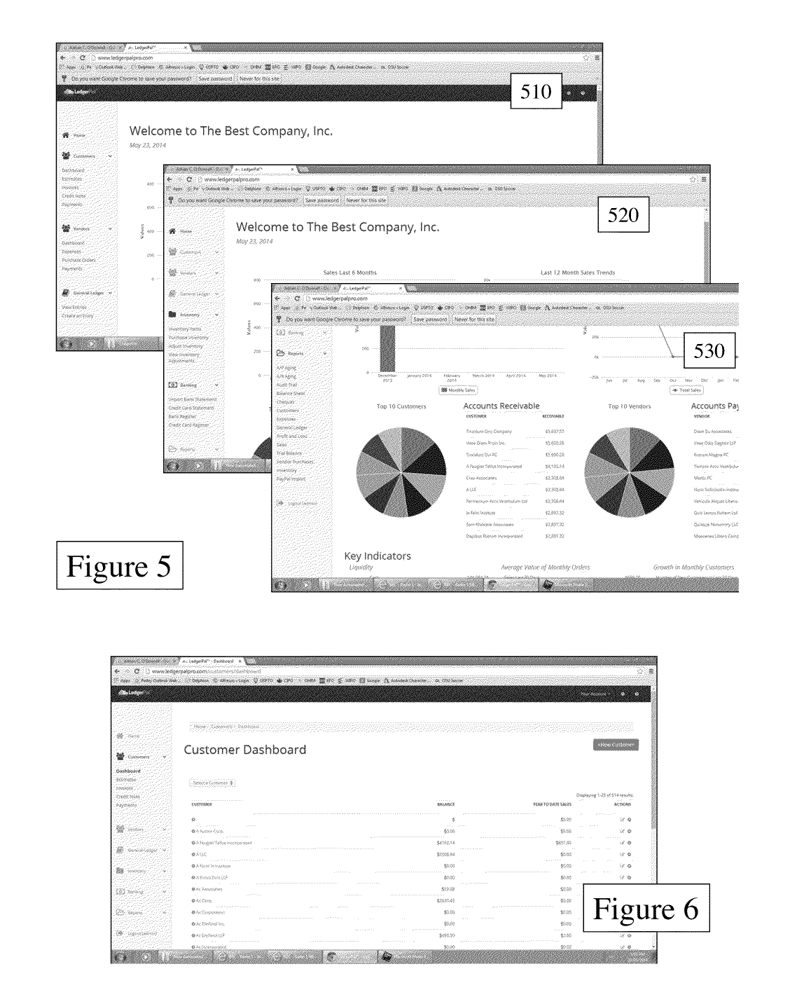

Selection of the other headers indicated in FIG. 4 within the initial dashboard triggers the dashboard to change to display the accessible items under each of the headers as depicted in FIG. 5 wherein first to third dashboard views are presented with these headers expanded to their lists for a FRSFRAP according to an embodiment of the invention. Accordingly these provide the following:
Customers: Dashboard, Estimates, Invoices, Credit Note, and Payments;
Vendors: Dashboard, Expenses, Purchase Orders and Payments;
General Ledger: View Entries and Create an Entry;
Inventory: Inventory Items, Purchase Inventory, Adjust Inventory, and View Inventory Adjustments; and
Banking: Import Bank Statement, Credit Card Statement, Bank Register, and Credit Card Register.

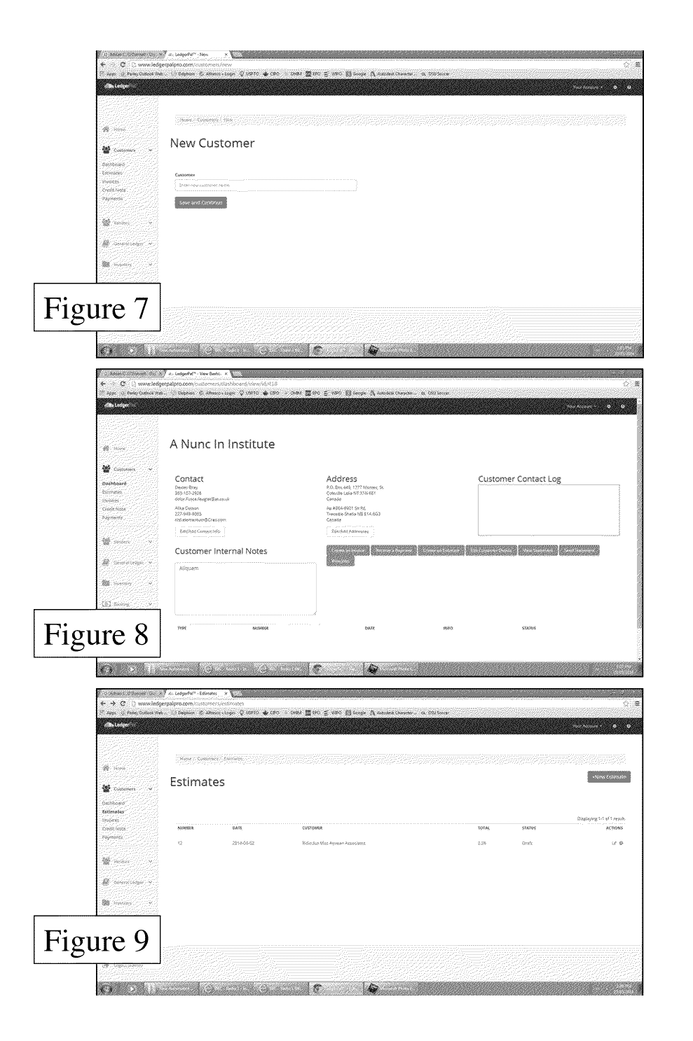

Now referring to FIGS. 6 to 8 there are depict customer dashboards presented to a user of a FRSFRAP according to an embodiment of the invention when selecting different options under the Customer heading. Accordingly, these are:
FIG. 6 wherein the customer dashboard is displayed providing a listing of customers alphabetically together with the balance and year to date sales for each customer listed, whilst adjacent to each are action buttons for editing the customer profile and deleting the customer which would be typically hidden for general users and displayed to an administrative user;
FIG. 7 wherein a new customer account can be entered based upon the information available and subsequently expanded as more details/information are established such as depicted in FIG. 8; and
FIG. 8 wherein a customer account is displayed showing the contacts, address information, internal notes for enterprise relating to the customer as well as buttons for creating an invoice, receiving a payment, creating an estimate, editing customer details, viewing statements, sending statements, and viewing jobs associated with the customer.

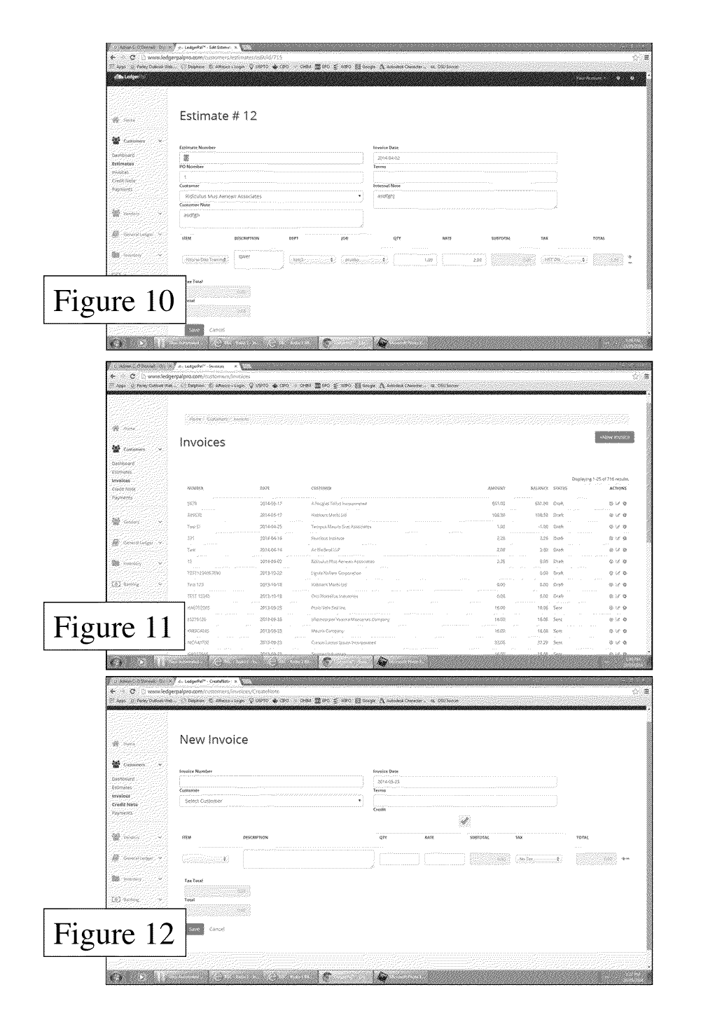

Accordingly a user may easily generate an estimate (quotation), create an invoice, post a payment, and check on the status, for example, from the same customer dashboard within the customer section of the FRSFRAP. If the user selects to view estimates associated with a customer then they are initially presented with FIG. 9 customer which depicts a customer estimate dashboards presented to a user of a FRSFRAP according to an embodiment of the invention. Selection of an estimate within the presented list results in the dashboard in FIG. 10 being depicted, in this case estimate #12 depicted in FIG. 9. This defines appropriate information such as estimate number, associated invoice if created, terms of estimate, internal name for estimate which may made identification easier, e.g. “Fred's New Project”, items with appropriate financial, quantity information etc.

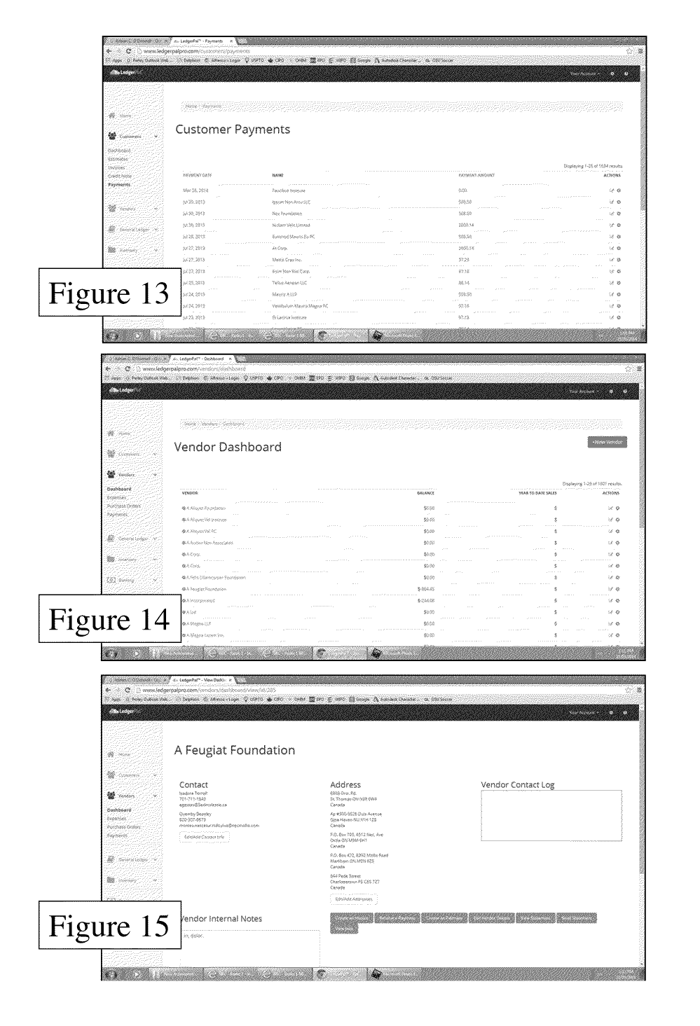

If alternatively, the user selects the Invoices option under the Customer heading then they are presented with FIGS. 11 to 13 depict invoicing and customer payment dashboards presented to a user of a FRSFRAP according to an embodiment of the invention. Accordingly, these are:
FIG. 11 depicts invoices sorted by date with key data such as invoice reference, customer, date, value, balance, and status, together with a button to generate a new invoice whilst adjacent to each invoice are action buttons for viewing the invoice in final form for printing etc., editing the invoice, and deleting the invoice which would be typically hidden to varying degrees for general users, financial personnel, administrative users etc.;
FIG. 12 wherein a user may generate a new invoice by selecting a customer and entering data directly or drop-down menus relating to the items within the invoice; and
FIG. 13 wherein customer payments are summarized whilst adjacent to each are action buttons for editing the customer profile and deleting the customer which would be typically hidden for general users and displayed to an administrative user.

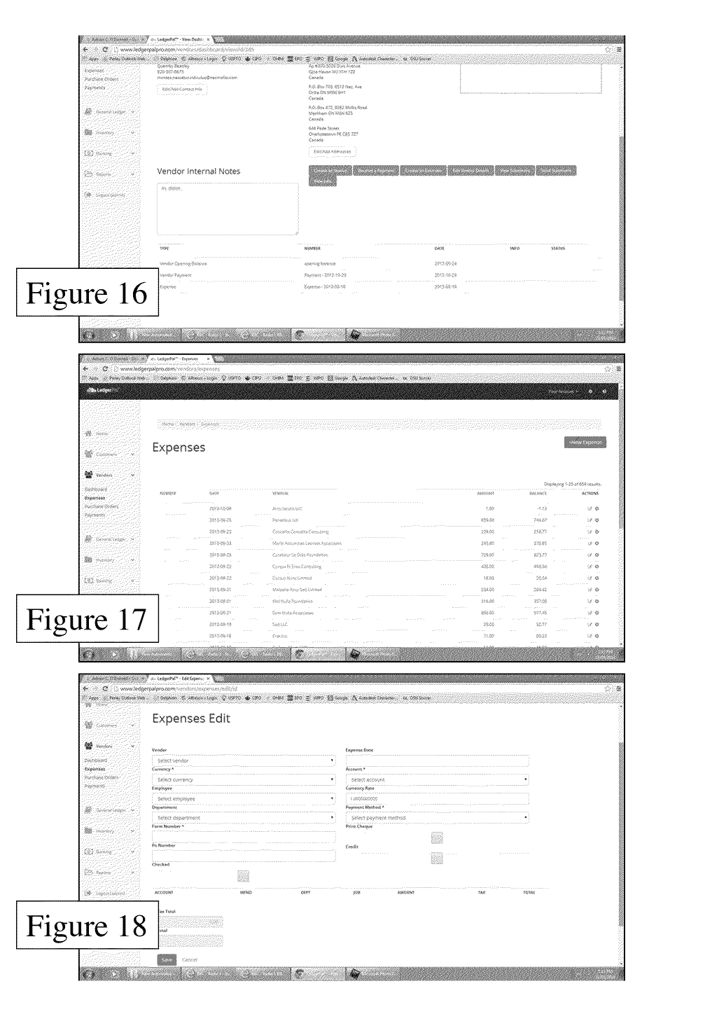

If alternatively, the user selects the dashboard option under the Vendor heading then they are presented with vendor dashboard in FIG. 14 and may navigate to subsequent vendor dashboards in FIGS. 15 and 16 as presented to a user of a FRSFRAP according to an embodiment of the invention. Accordingly these are:
FIG. 14 wherein the vendor dashboard is displayed providing a listing of vendors alphabetically together with the balance and year to date sales for each vendor listed, whilst adjacent to each are action buttons for editing the vendor profile and deleting the vendor which would be typically hidden for general users and displayed to an administrative user; and
FIGS. 15 and 16 wherein a vendor account is displayed showing the contacts, address information, internal notes for enterprise relating to the vendor as well as buttons for creating an invoice, receiving a payment, creating an estimate, editing vendor details, viewing statements, sending statement, and viewing jobs associated with the customer.

If alternatively, the user selects the Expenses option under the Vendor heading then they are presented with FIGS. 17 and 18 that depict expense dashboards presented to a user of a FRSFRAP according to an embodiment of the invention, wherein:
FIG. 17 is an expenses summary dashboard listing information such as date, vendor, amount, balance, etc. and adjacent to each are action buttons for editing the vendor expense and deleting an individual which would be typically hidden for general users and displayed to an administrative/financial user; and
FIG. 18 presented to the user when they select the New Expense button in the expenses summary dashboard wherein through data entry fields and drop-down menus the user can select vendor, currency, employee, department, expense date, account, currency rate, payment method etc. etc. to enter the new expense.

Within dashboards such as the expenses summary dashboard, vendor dashboard, etc. elements are displayed to the user as text, action buttons, etc. but also as hyperlinks etc. Accordingly, selecting the vendor “Arcu laculis LLC” in the first expense in expenses dashboard depicted in FIG. 17 results in the user being presented with the dashboard for “Arcu laculis LLC” as the vendor “Arcu laculis LLC” is a hyperlink as indicated, for example, by different colour text and underline.

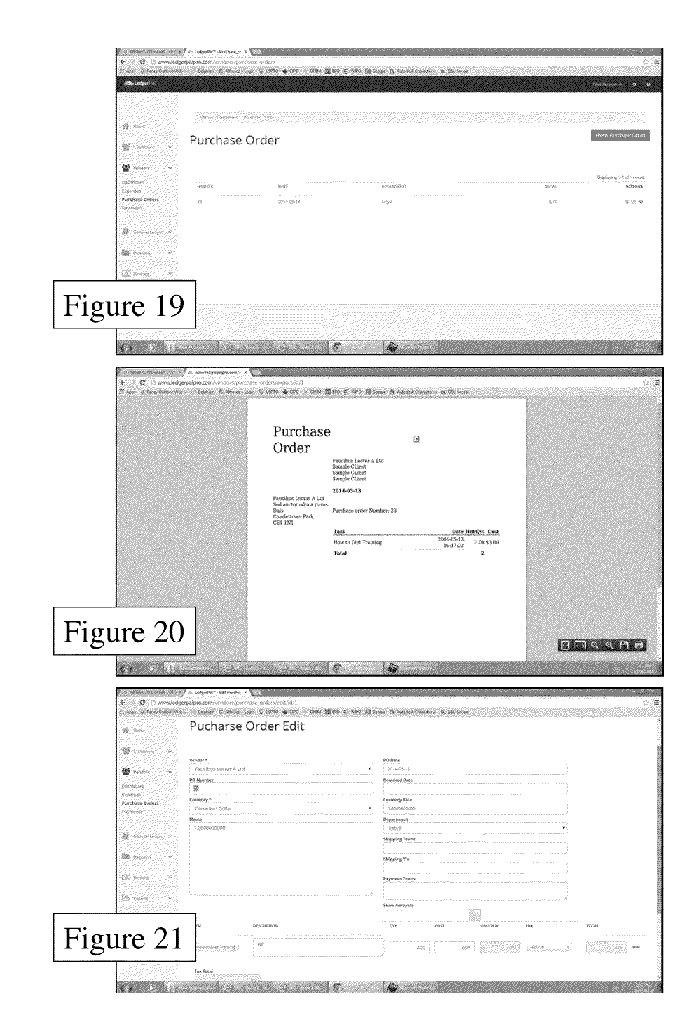

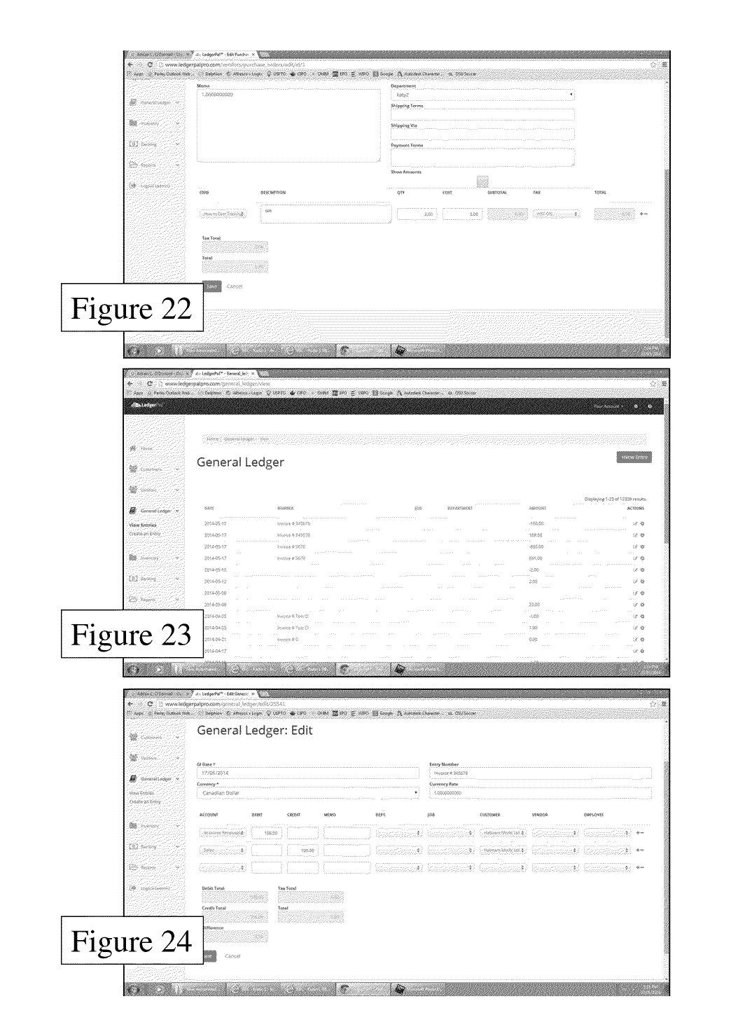

If alternatively, the user selects the Purchase Order option under the Vendor heading then they are presented with FIGS. 19 to 22 which depict purchase order dashboards presented to a user of a FRSFRAP according to an embodiment of the invention. Accordingly these are:
FIG. 19 depicts a list of Purchase Orders summary listing information such as date, purchase order number, department, amount, etc. and adjacent to each are action buttons for the viewing the Purchase Order, editing the Purchase Order, and deleting a Purchase Order wherein these may be visible/hidden in varying combinations for general users, financial personnel, administrative users etc.;
FIG. 20 which displays a generated Purchase Order when a user selects the button for viewing a Purchase Order wherein this may be printed for records and/or mailing or alternatively saved to a memory for subsequent retrieval and/or transmission as an attachment to a vendor; and
FIGS. 21 and 22 which display a dashboard for a user when the user selects the button for editing a Purchase Order wherein they can amend the vendor, Purchase Order (PO) number, currency, notes (memo), shipping terms, payment terms, shipping route, etc. as well as the items, quantities, descriptions, costs, etc. for the item(s) from the vendor as well as rapidly and easily through Tax drop-down menu adjust the tax type to be associated, e.g. no tax, Ontario Harmonized Sales Tex (HST), Ontario Provisional Sales Tax (PST), New York Sales Tax, etc.

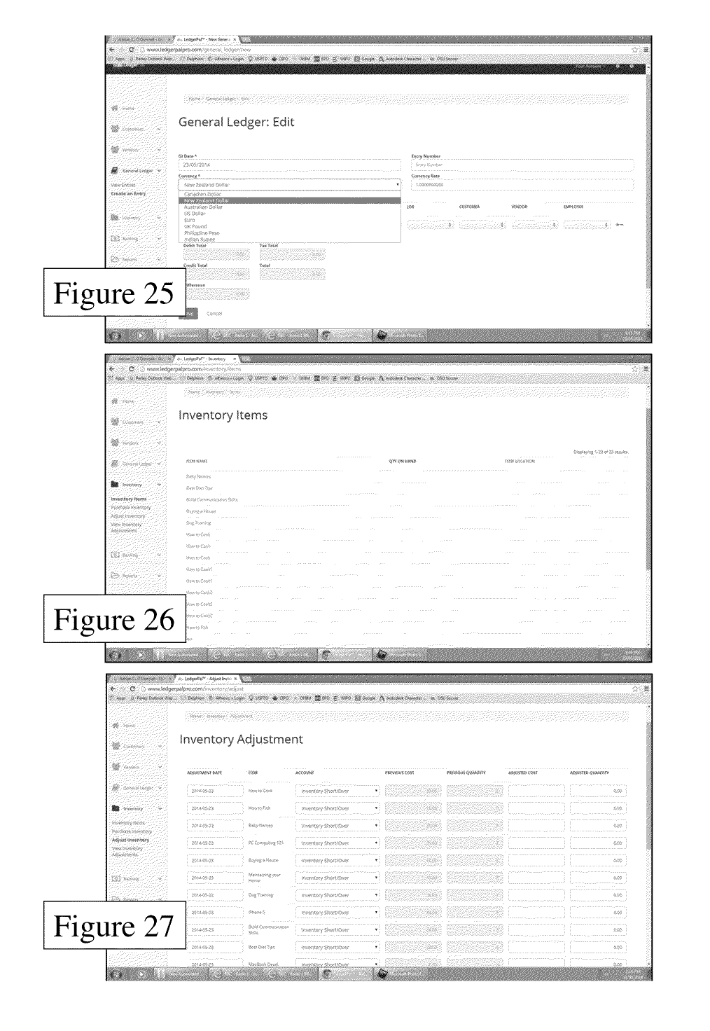

If alternatively, the user selects the View Entries option under the General Ledger heading then they are presented FIGS. 23 to 25 depict general ledger dashboards presented to a user of a FRSFRAP according to an embodiment of the invention. Accordingly, these are:
FIG. 23 depicts a list of General Ledger (GL) summary listing information such as date, reference number, department, amount, etc. and adjacent to each are action buttons for the editing the GL entry and deleting a GL entry wherein these may be visible/hidden in varying combinations for general users, financial personnel, administrative users etc.;
FIGS. 24 and 25 which display a dashboard for a user when the user selects the button for editing a General Ledger entry wherein they can amend the details including, but not limited, what accounts the entry relates to, whether debit/credit, memo, department, job, customer, vendor, employee, etc.

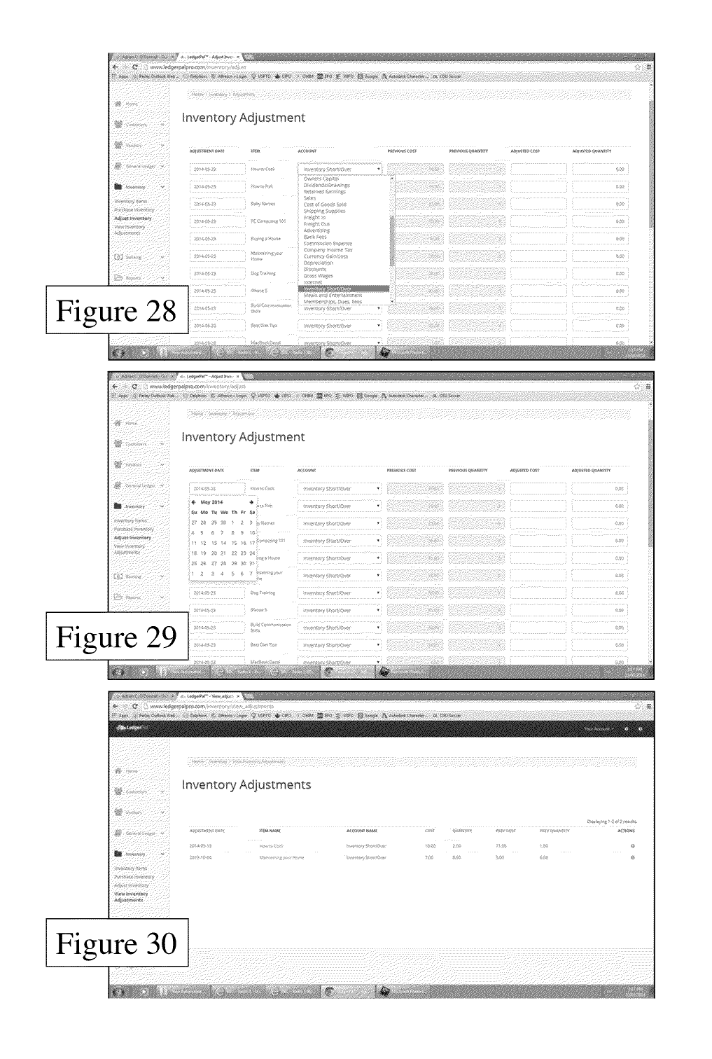

If alternatively, the user selects the Inventory Items, Adjust Inventory, and View Inventory Adjustments option under the Inventory heading then they are presented with FIG. 26, FIGS. 27 to 29, and FIG. 30 respectively as relating to inventory dashboards for a FRSFRAP according to an embodiment of the invention. Accordingly, these are:
FIG. 26 depicts a list of Inventory Items relating to the enterprise showing these as a list by name, with the quantity of hand, and their location(s) wherein selection of an item with the list would bring up a product screen outlining data including, but not limited to, vendor, pricing, lead time, etc.;
FIGS. 27 to 29 depict an Inventory Adjustment screen and adjustment screens respectively where the user has selected to Adjust Inventory, such that in FIG. 27 they are presented with initial dashboard presenting a list of inventory items and the user may make adjustments wherein the user may adjust the account relating to the inventory item, the new adjusted cost, the new adjusted quantity etc. such that, for example, selection of Account and Adjustment Date yields displays of drop-down items such as depicted in FIGS. 28 and 29 respectively; and
FIG. 30 which depicts the historical record of inventory adjustments made.

Accordingly, when an adjustment is made to an item it is viewable in the View Inventory Adjustment dashboard but the adjustments made are reflected within Inventory Adjustment dashboard and Inventory Items. Accordingly, a user may ascertain that there is insufficient inventory for a contract but that the item at issue was recently adjusted based upon completing an order for another customer and hence may, if the order with insufficient inventory, is to a higher priority customer to engage others within the Enterprise to address the issue and manage inventory to keep both customers happy or the higher priority customer.

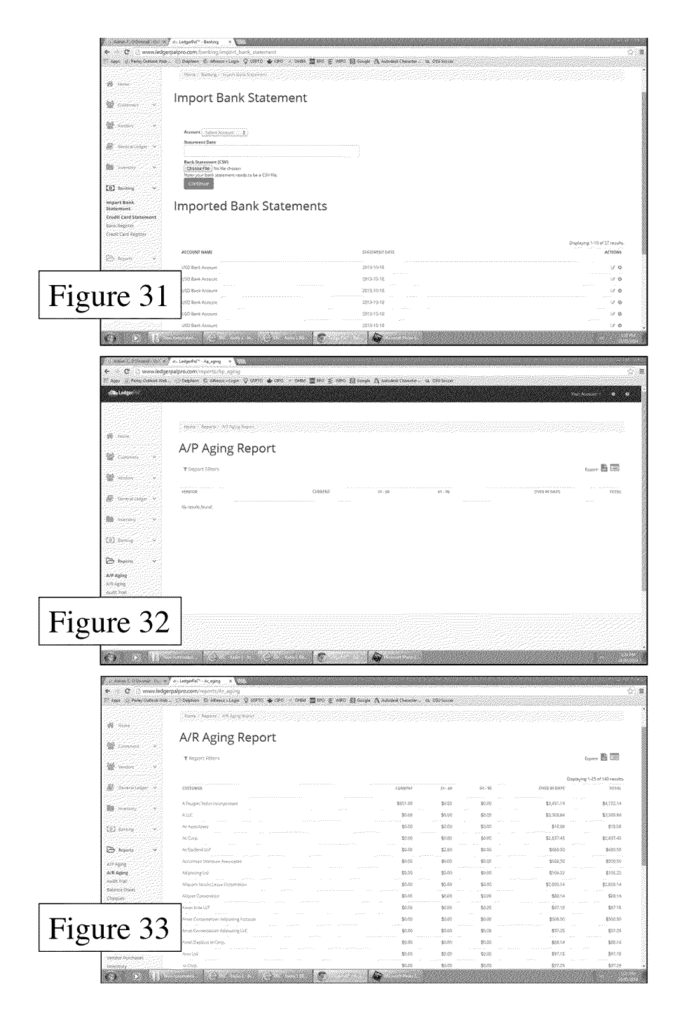

Referring to FIG. 31 there is depicted a bank statement dashboard presented to a user of a FRSFRAP according to an embodiment of the invention where the user has selected the Import Bank Statement under the Banking header. Accordingly, within the dashboard of FIG. 31 they can select an account, select a date, choose a file, and import this. Whilst the dashboard denotes that the file format is comma separated value (CSV) other formats may be supported according to the financial institution(s). Also depicted are the historical records of bank statements previously imported together with action buttons for the viewing the imported statement or deleting record of an imported statement although this may or may not within embodiments of the invention reverse the financial entries.

Selection of items bank register and credit card register allows a user to add/modify/delete associations of bank accounts and credit cards respectively to the financial activities of the enterprise/user. Optionally, other financial instruments may also be associated and/or managed without departing from the scope of the invention.

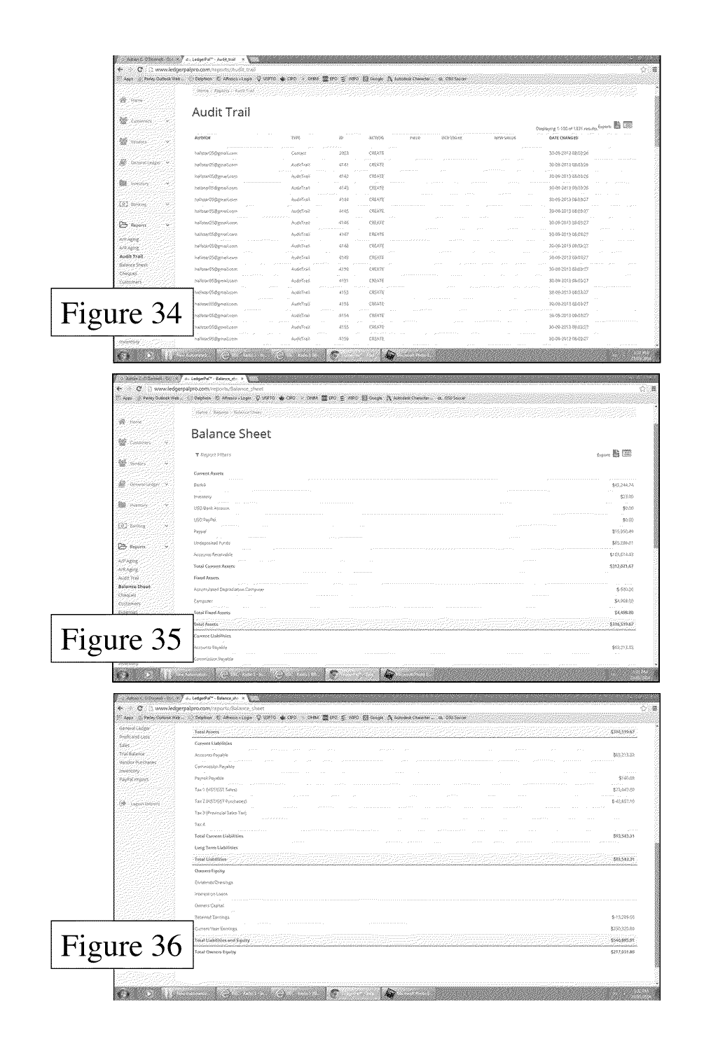

If alternatively, the user selects the Accounts Payable (A/P) Aging, Accounts Receivable (A/R) Aging or Audit Trail under the Reports heading then they are presented with FIGS. 32, 33 and 34 respectively that depict accounts payable aging dashboards presented to a user of a FRSFRAP according to an embodiment of the invention. Accordingly, these are:
FIG. 32 allowing a user to create an A/P aging report for a period of time as of a selected date allowing the A/P aging to be viewed historically and currently to mine data for the enterprise, wherein upon selecting the GO button the A/P aging report is run and displayed after which the user may export this through the icons in upper right to printable format, e.g. for physical printing or storing as PDF for example, or saving as a data file for subsequently emailing to another user or importing to another software application;
FIG. 33 allowing a user to create an A/R aging report for all records or for a period of time as of a selected date allowing the A/R aging to be viewed historically and currently to mine data for the enterprise, wherein upon selecting the GO button the A/R aging report is run and displayed after which the user may export this through the icons in upper right to printable format, e.g. for physical printing or storing as PDF for example, or saving as a data file for subsequently emailing to another user or importing to another software application; and
FIG. 34 displays an audit trail of activities performed wherein these are logged by identity of the user performing the change to the financial records (e.g. the author) wherein these may be associated by their email address for example, and then there is listed the audit record for each change including, for example, the area associated with the change (e.g. Contact, Item, Inventory, etc.), an identity, the action performed (e.g. create, delete, modify, etc.), what field(s) were amended and their old/new values together with date/time of the change. Similarly, icons in upper right relate to printable format, e.g. for physical printing or storing as PDF for example, or saving as a data file for subsequently emailing to another user or importing to another software application

In this manner the enterprise may maintain a full audit trail allowing identified accounting issues to be tracked to specific actions either so that these can be reversed and/or procedures amended to try and avoid the issue recurring. Equally, a user's access/rights may be adjusted. Where the user selects the Balance Sheet item under the Reports heading then they are presented with a balance sheet which may require the user scrolling to view the entire balance sheet such as depicted in FIGS. 35 and 36 depict a balance sheet dashboard presented to a user of a FRSFRAP according to an embodiment of the invention. As depicted in FIG. 35 the user may apply a filter to the balance sheet which includes an “As of Date” for the balance sheet to be run, a period of time for the balance sheet, a department to limit the balance sheet to, and the ability to remove balance sheet items with zero balance to simplify the balance sheet.

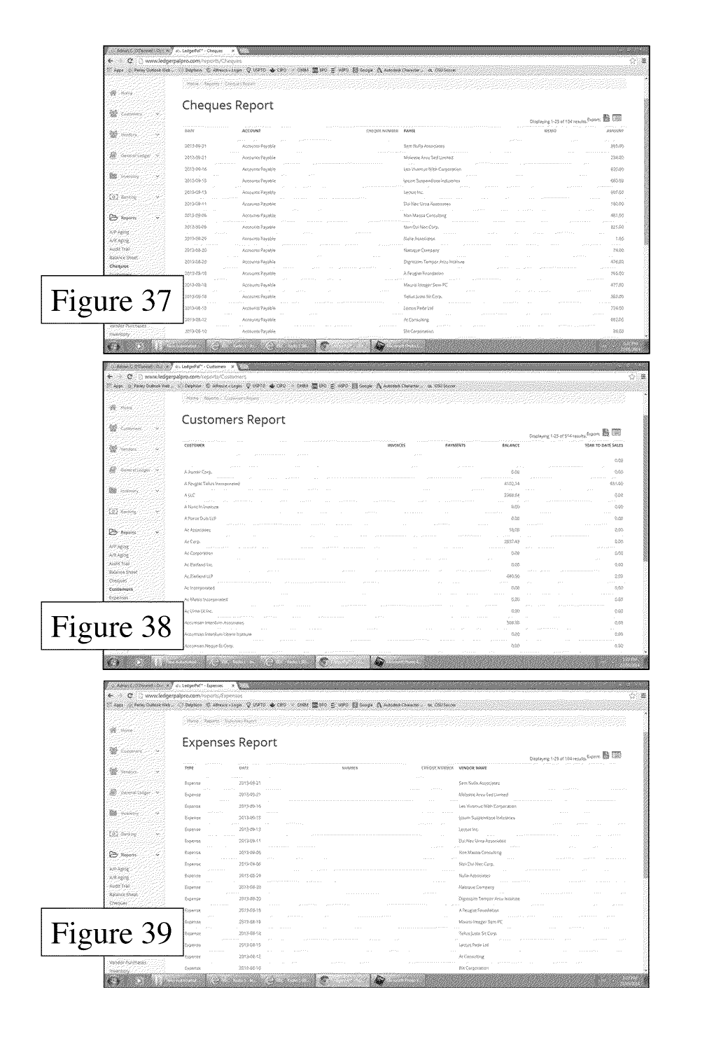

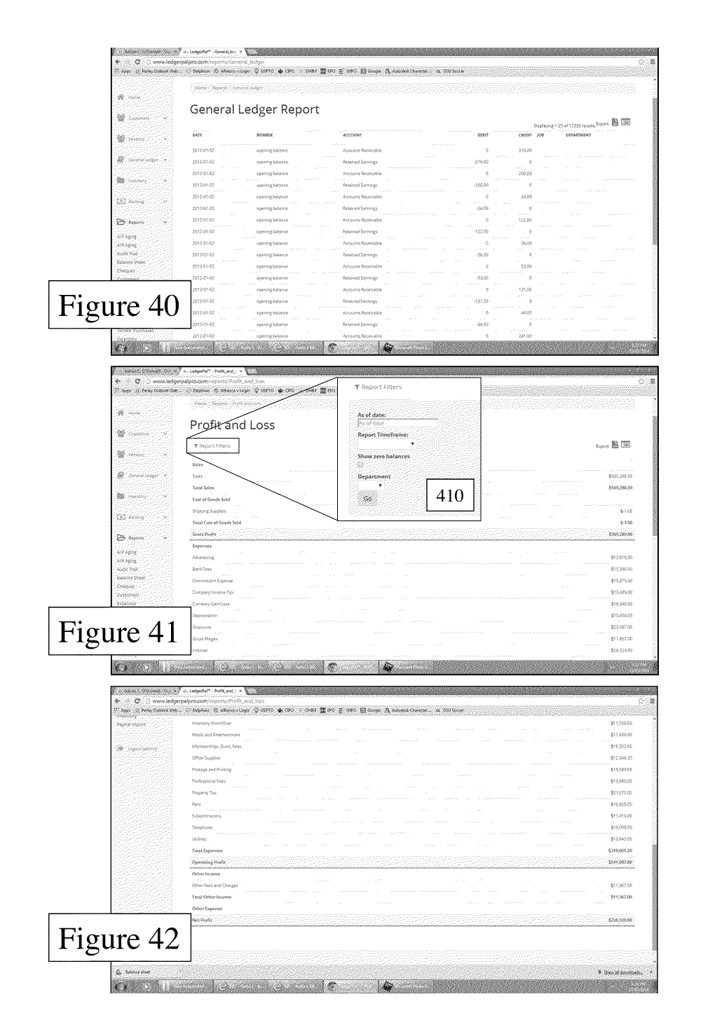

If alternatively, the user selects the Cheques Report, Customers Report, Expenses Report, and General Ledger under the Reports heading then they are presented with FIGS. 37 to 40 respectively depicting reporting dashboards presented to a user of a FRSFRAP according to an embodiment of the invention. Accordingly, these are:
FIG. 37 depicts a historical record of cheques issued by the enterprise with information such as date, account, cheque number, payee, and amount where through the icons in upper right relating to printable format, e.g. for physical printing or storing as PDF for example, or saving, e.g. as a data file for subsequently emailing to another user or importing to another software application, the user may export these records;
FIG. 38 depicts a list of customers together with running totals for invoices issued, payments received, and balance together with a calculation of year to date sales which may be presented as a currency figure or alternatively as a percentage of enterprise revenues to date where again this may be exported for printing or stored for record keeping, electronic mailing, or transfer to another software application;
FIG. 39 depicts a list of expenses together with type, date, reference number, cheque number, vendor name and again this may be exported; and
FIG. 40 depicts a General Ledger report detailing transactions including details such as date, account, financial value debited and/or credited, job, and department including the same options for printing or storing.

Now referring to FIGS. 41 and 42 there are depicted upper and lower portions of a profit and loss dashboard presented to a user of a FRSFRAP according to an embodiment of the invention summarizing sales, gross profit, expenses, operating profit, etc. and net profit over the period established by the user when selecting the report filter as depicted in insert 410 when opened.

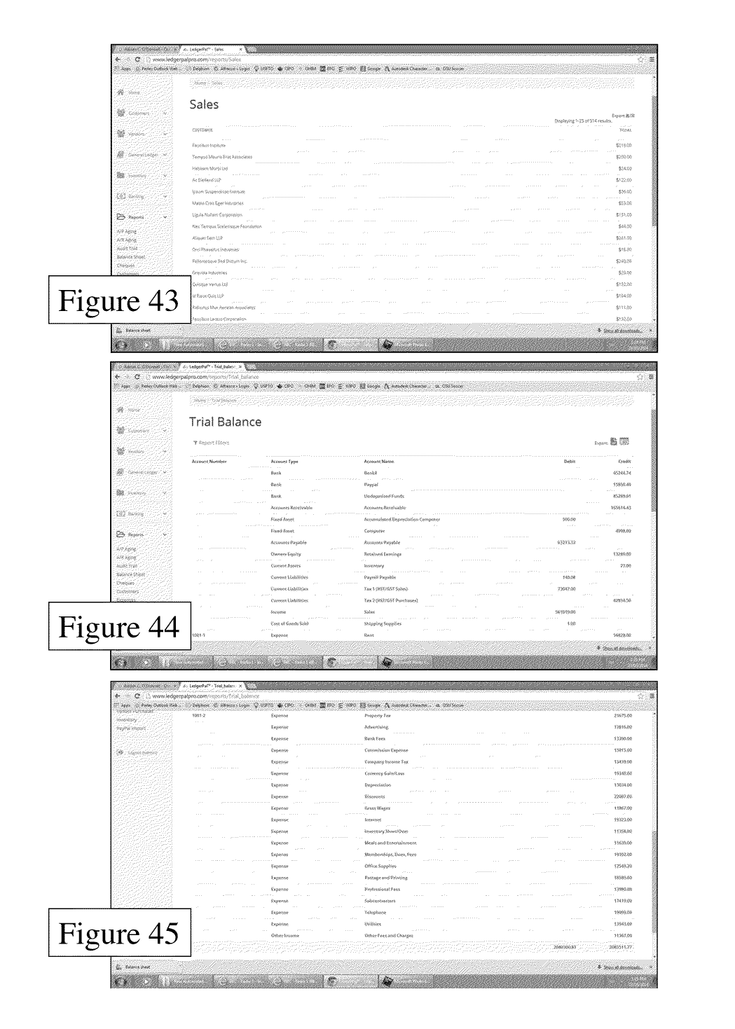

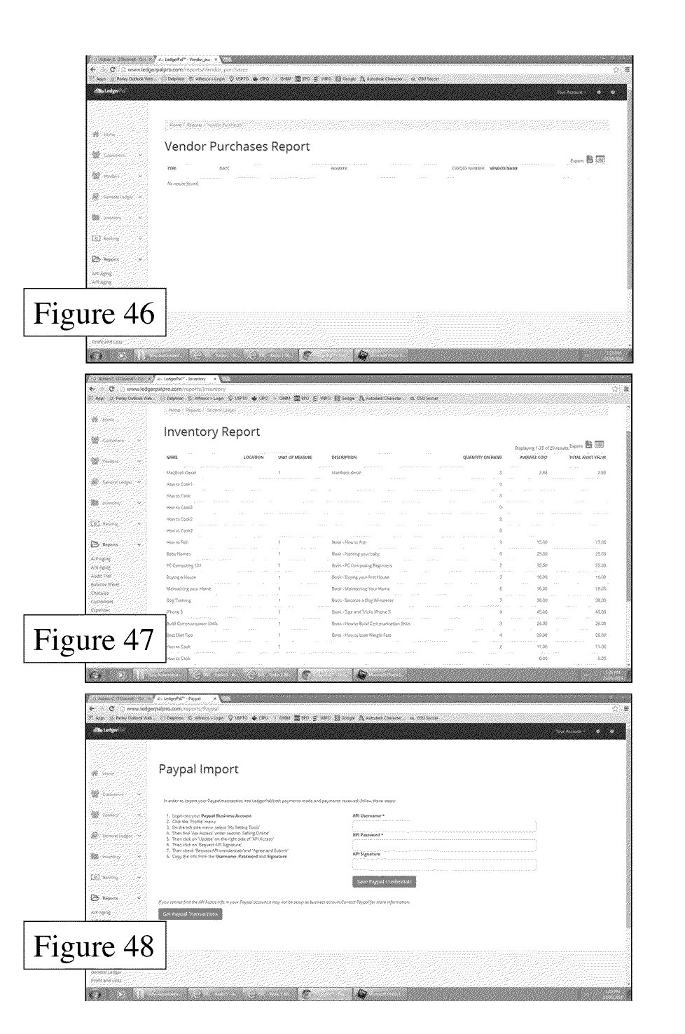

FIGS. 43 to 47 depict reporting dashboards presented to a user of a FRSFRAP according to an embodiment of the invention based upon the selection of the appropriate items under the Reports heading. These being:
FIG. 43 depicts a dashboard presented when a user selects the Sales item under the Reports heading wherein they are presented with a record of sales by customer with buttons for exporting in PDF format or electronically for another software application;
FIGS. 44 and 45 depict a dashboard relating to a trial balance for the enterprise listing accounts, account names, debit/credit standing with the normal report filter setting and export options;
FIG. 46 depicts a dashboard presented when a user selects the Vendor Purchase Report item under the Reports heading wherein they are presented with a record of vendor purchases with fields for type, date, reference number, cheque number, and vendor name as well as the usual buttons for exporting in PDF format or electronically for another software application; and
FIG. 47 depicts a dashboard presented when a user selects the Inventory Report item under the Reports heading wherein they are presented with a list of products together with data relating to location, unit of measure, description, quantity of hand, average cost and total asset value as well as the usual buttons for exporting in PDF format or electronically for another software application.

Referring to FIG. 48 depicts a PayPal™ importing dashboard presented to a user of a FRSFRAP according to an embodiment of the invention wherein amongst their methods of receiving payment and/or providing payment is PayPal™. Accordingly, the user may import the records of their PayPal™ transactions into the FRSFRAP in a similar manner to the importing of bank statements as described supra. This as depicted requires providing details to access an application programming interface (API) such as user name, password, and attaching an electronic API signature, for example.

Accordingly, a financial accounting system and financial reporting application/platform (FRSFRAP) according to embodiments of the invention and as described supra in respect of FIGS. 1 to 48 provides a user and/or users discretely or in association with one or more enterprises with a cloud based software application/system allowing various electronic inputs received from PEDs and/or FEDs together with other financial systems (e.g. bank records, PayPal™ records, credit card statements, etc.) to be automatically collected, processed, etc. for verified multiple factor authenticated users wherein the artificial intelligence within the FRSFRAP then provides for provisioning reports and documents to authorized recipients.

By exploiting multiple factor authentication, described as two-factor, but others may be employed in combination with communication encryption techniques allows the FRSFRAP to automatically approve payments, manage submission and processing of employee expense reports, provide for automated distribution of scheduled business reports, etc.

Referring back to FIG. 3 a wide range of information sources may provide data to a FRSFRAP according to embodiments of the invention including, but not limited to:

1. Internet Shopping Carts and Internet integrated website and shopping cart services that provide either electronic reports/exports/files or APIs.

2. PoS systems, including for example cash registers, scanners, etc.

3. Sales Personnel inputting orders and invoices on mobile devices or directly into the FRSFRAP via a sales screen during sales visits.

4. PayPal™ and other financial card processors or financial aggregators who provide either electronic reports/exports/files or API based data access.

5. Banks or financial aggregators who provide either electronic reports/exports/files or an API based data access.

6. Procurement personnel inputting orders and bills on mobile devices or directly into the FRSFRAP via a procurement screen.

7. Vendors Data Entry whereby vendors may authorize/generate purchase orders, converting them to bills, uploading or creating their bills directly in the FRSFRAP as an authorized user with restrictions.

8. Employees inputting expenses for reimbursement on mobile devices or directly into the FRSFRAP via an employee expense screen

9. Documents (spreadsheet type or word type) residing on a remote server (in the cloud) or local server that has cells and blocks of data mapped to fields in the FRSFRAP database.

10. Electronic Data Interchange to third party systems.

11. Any other suitable API (application programming interface) providing data of an accounting nature,

12. Manual inputting on mobile devices or directly into the FRSFRAP via a manual input screen, e.g. making a direct general ledger or journal entry, or setting up the system.

With reference to embodiments of the invention described supra in respect of FIGS. 1 through 48 a FRSRAP may exploit a plurality of algorithms to providing processing, analysis, matching etc. of data relating to transactions intelligently to other entries with the FRSRAP. Accordingly, such networks may exploit a variety of techniques including, but not limited, to:
Approximation Wherein various properties (e.g. value, quantity, product, customer, etc. may be matched based upon being nearly but not exactly the same. The approximation algorithm used may depend on the available information, the sensitivity of the problem to the data, the criticality of the data, for example.
Averaging Typically, averaging refers to the arithmetic mean, however it may also be applied to the median, the mode, or some other central or typical value of data to allow the matching of the data to entries within the FRSRAP database.
Pattern recognition Wherein the FRSRAP artificial intelligence focuses to the recognition of patterns and regularities/irregularities in the data. In some instances, these patterns may be learned from labeled “training” data via supervised learning, but when no labeled data is available pattern recognition algorithms can be used to discover previously unknown patterns (unsupervised learning) and match data. For a list of examples of pattern recognition algorithms etc. see for example http://en.wikipedia.org/wiki/Pattern_recognition.
Filtering May be applied through a variety of processes including but not limited to, treating data received as part of special subset of a partially ordered set, see for example http://en.wikipedia.org/wiki/Filter_(mathematics)#Filters_in_model_theory, as well as processing received data which are treated as stochastic processes, wherein the filtering problem is a mathematical model for a number of filtering problems to form some kind of “best estimate” for the true value of some system, given only some (potentially noisy) observations of that system, see for example http://en.wikipedia.org/wiki/Filtering_problem_(stochastic_processes).
Novelty detection Wherein processing is applied in the identification of new or unknown data as evolving product ranges, pricing strategies, ordering/delivery loadings etc. as a machine learning system cannot be trained with all or cannot be previously aware of invoicing, ordering, delivery data and patterns wherein examples of novelty detection include statistical and/or neural network based approaches.

Embodiments of the invention described and depicted in respect of the specification and FIGS. 1 to 48 may exploit artificial intelligence/neural networks and/or fuzzy logic in order to perform a variety of processing including, but not limited to:
Problem Solutions including but not limited to, classification, clustering, regression, anomaly detection, association rules, reinforcement learning, structured prediction, feature learning, online learning, semi-supervised learning, and grammar induction.
Supervised Learning including but not limited to, classification, regression, decision trees, ensembles (Bagging, Boosting, Random forest), k-NN, linear regression, naive Bayes, neural networks, logistic regression, perceptron, and support vector machine (SVM).
Clustering including but not limited to, BIRCH, hierarchical, k-means, expectation-maximization (EM), DBSCAN, OPTICS, and mean-shift.
Dimensionality reduction including but not limited to, factor analysis, CCA, ICA, LDA, NMF, PCA, and t-SNE.
Structured prediction including but not limited to, graphical models such as Bayes net, CRF, and HMM.
Anomaly detection including but not limited to, k-NN, local outlier factor.
Neural nets including but not limited to, autoencoder, deep learning, multilayer perceptron, RNN, restricted Boltzmann machine, and SOM.

Accordingly, the cloud based distributed processing and distributed/backed up database(s) within the FRSFRAP exploit artificial intelligence algorithms to provide a number of services and/or features to users including, but not limited to, those listed below.

1. A method or process to map the various received inputs automatically to fields in the FRSFRAP database.

2. A method or process to analyze and match transactions intelligently to other entries within the FRSRAP using methodologies including, but not limited to, approximation, averaging, pattern recognition, filtering, and novelty detection.

3. A method or process to generate accounting reports and documents.

4. A method or process to securely request authorization for payments.

5. A method or process to create and send payments to authorized recipients.

6. A method or process to intelligently reconcile accounts.

7. A method or process to intelligently generate projections within the FRSFRAP, such as future sales projections, using methodologies including, but not limited to, averaging, regression, time/series and pattern recognition.

8. A method or process to intelligently calculate taxes when only the after-tax figure and jurisdiction is known

9. A method or process to intelligently “remember” and apply accounts or vendors or customers or employees based only on the transaction amount and date or minimal extra data.

10. A method or process to intelligently calculate and generate just in time purchases.

11. A method or process to intelligently request multiple factor authentication prior to actioning secure processes such as payments.

12. A method or process whereby the invention makes projections based upon at least one of user inputs, user input selections, setup mapping, and user editing choices.

Different reports and documents that are pushed out to authorized recipients, as depicted on the right hand side of FIG. 3, including, but not limited to:

1. Standard or lean accounting reports including, but not limited to, ad hoc reports, on demand pre-formatted reports and scheduled reports.

2. Business intelligence reports.

3. Intelligence projections.

4. Automated payroll payments or other payments or refunds and requests for authorizing those payments or refunds.

5. Automatic or recurring invoices or purchase orders.

6. Automatic bank reconciliations.

7. Automated scheduled reports and customized reports.

The FRSFRAP according to embodiments of the invention exploits a collection of algorithms which reduce the requirements for manual input and manual output for accounting. In one embodiment of the present invention, the database and intelligent processing are hosted in the cloud, for example through environments such as Amazon Web Services or Rackspace. In the other embodiment the database and intelligent processing may be hosted in a local data center(s) or even local server(s).

It would be evident that the methods and embodiments of the invention may, in addition to accounting, be employed for other applications including, but not limited, enterprise resource planning systems, enterprise management systems, treasury systems, e-commerce systems, Internet and Cloud based management systems, financial systems, and banking systems.

The FRSFRAP accordingly provides a web based application allowing a user to enter relating to an enterprise and then executes at least one algorithm of a plurality of algorithms upon the data entered, where the at least one algorithm selected in dependence upon at least the data entered, and then determine whether to perform an action in dependence upon the result of executing the at least one algorithm of a plurality of algorithms upon the data entered by the user.

Exploiting the artificial intelligence within the FRSFRAP then the FRSFRAP can:
map data entered to fields within a financial database stored upon a server;
match the data entered to at least one transaction of a plurality of transactions stored within a database by applying at least one of approximation, averaging, pattern recognition, filtering, and novelty detection to the data entered;
generate least one of an accounting report and an accounting document;
generate a secure request for authorization of a payment;
generate and transmit payment to an authorized recipient;
reconcile financial accounts;
generate a financial projection by applying at least one of averaging, regression, time/series recognition, and pattern recognition to stored data either as entered or as generated by the one or more algorithms processing data;
store and apply account related information relating to at least one of vendor, customers, and employees based upon the transaction amount and date of transaction within the user entered data; and
establish assumptions for processing the data entered by the user based upon previous at least one of user inputs and choices, user setup, and user selections.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of providing financial services to a user comprising:
providing a web based application allowing the user to enter data relating to an enterprise;
executing within the web based application at least one algorithm of a plurality of algorithms upon the data entered, the at least one algorithm selected in dependence upon at least the data entered; and
determining with the web based application whether to perform an action of a plurality of actions in dependence upon the result of executing the at least one algorithm of a plurality of algorithms upon the data entered by the user.

2. The method according to claim 1, wherein the at least one algorithm of a plurality of algorithms maps the data entered to fields within a database stored upon a server.

3. The method according to claim 1, wherein the at least one algorithm of a plurality of algorithms matches the data entered to at least one transaction of a plurality of transactions stored within a database by applying at least one of approximation, averaging, pattern recognition, filtering, and novelty detection to the data entered.

4. The method according to claim 1, wherein the action is the generation of at least one of an accounting report and an accounting document.

5. The method according to claim 1, wherein the action is the generation of a secure request for authorization of a payment.

6. The method according to claim 1, wherein the action is the generation and transmittal of a payment to an authorized recipient.

7. The method according to claim 1, wherein the action is the reconciliation of financial accounts.

8. The method according to claim 1, wherein the action is the generation of a projection relating to a financial aspect of the enterprise by applying at least one of averaging, regression, time/series recognition, and pattern recognition to stored data generated by the at least one algorithm of the plurality of algorithms.

9. The method according to claim 1, wherein the web based application exploits artificial intelligence to store and apply account related information relating to at least one of vendor, customers, and employees based upon the transaction amount and date of transaction within the user entered data.

10. The method according to claim 1, wherein the user entering data comprises the user importing data to the web based application through an application programming interface from a financial service provider.

11. The method according to claim 1, the web based application exploits artificial intelligence to establish assumptions for processing the data entered by the user based upon previous at least one of user inputs and choices, user setup, and user selections.
